(19) United States
(12) Patent Application Publication
(10) Pub. No.: US 2013/0188373 A1
(43) Pub. Date: Jul. 25, 2013

(54) TELESCOPIC ILLUMINATING DEVICE

(71) Applicant: PI-FEN LIN, TAIPEI CITY (TW)

(72) Inventor: PI-FEN LIN, TAIPEI CITY (TW)

(21) Appl. No.: 13/355,499

(22) Filed: Jan. 21, 2012

(51) Int. Cl. F21S 8/08

(52) U.S. Cl. 362/410

(57) ABSTRACT

A telescopic illuminating device includes a base support, a telescopic shaft, a light source, and a driving mechanism. One end of the telescopic shaft is connected to the base support, while the other end of the telescopic shaft is connected to the light source. The driving mechanism is connected to the telescopic shaft to drive the telescopic shaft of performing extension or retraction motions. Thus, the light source of the telescopic illuminating device is vertically adjustable to reach different height levels through automation.

### BACKGROUND OF THE INVENTION

1. Field of the Invention

The instant disclosure relates to an illuminating device; in particular, to a telescopic illuminating device capable of adjusting the height of the light source in accordance to the user's requirements.

2. Description of Related Art

People of the modern world are pursuing a better life quality along with the enhanced living standard, and particularly to a demand of a better environmental quality with enhanced aesthetics. Other than decorations through daily necessities and household furniture, the ornamental design of a lighting device has considered to be another most important factor influencing the comfort and aesthetic of an environment. Therefore, a well-designed illuminating device has gradually earned its part in the necessities of a modern daily life.

Currently, illuminating devices such as the floor lamps, the standard lamps, or the table lamps enjoy most popularity. Nevertheless, the light sources of conventional illuminating device are usually affixed to a predetermined position, unable to adjust the positioning according to the user's requirements. Therefore, although some illuminating devices are telescopically designed to enable the adjustment of the lightposts by hand to change the height level of the light sources, such illuminating devices still remain inconvenient for users as they are operationally laborious.

### SUMMARY OF THE INVENTION

The object of the instant disclosure is to provide a telescopic illuminating device capable of self-adjusting the height level of the light source.

In order to achieve the aforementioned object, according to an embodiment of the instant disclosure, a telescopic illuminating device is provided, including a base support, a light source, a telescopic shaft coupled therebetween, and a driving mechanism attached to the telescopic shaft.

The instant disclosure further provides another telescopic illuminating device, including a base support, a light source, and a driving mechanism; and the driving mechanism is arranged on the base support, while the light source is connected to the driving mechanism.

The instant disclosure has the following advantages: the elevation of the light source is adjustable to reach different height levels through the driving mechanism. Thereby, the object of meeting the user's requirement of illuminating at any preferred position can be achieved.

Furthermore, the height level of the light source of the instant disclosure is self-adjustable in providing easier operation.

Additionally, the telescopic shaft of the instant disclosure can be designed in a curved manner such that an arched structure is formed when extending the telescopic shaft. This structural design enables the light source of the illuminating device to be adjustable in the vertical direction, and even in the horizontal direction in providing a more complete adjustment.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a three-dimensional perspective view of the telescopic illuminating device in accordance to the instant disclosure;

FIG. 2 shows a side view of the telescopic illuminating device in accordance to the instant disclosure;

FIG. 3 shows a side view of the telescopic illuminating device at retracted position in accordance to the instant disclosure;

FIG. 4 shows a cross-sectional view of the telescopic illuminating device in accordance to the instant disclosure;

FIG. 5 shows a cross-sectional view of the telescopic illuminating device of another embodiment in accordance to the instant disclosure;

FIG. 6 shows a side view of the telescopic illuminating device of yet another embodiment in accordance to the instant disclosure;

### DETAILED DESCRIPTION OF THE PREFERRED EMBODIMENTS

### The First Embodiment

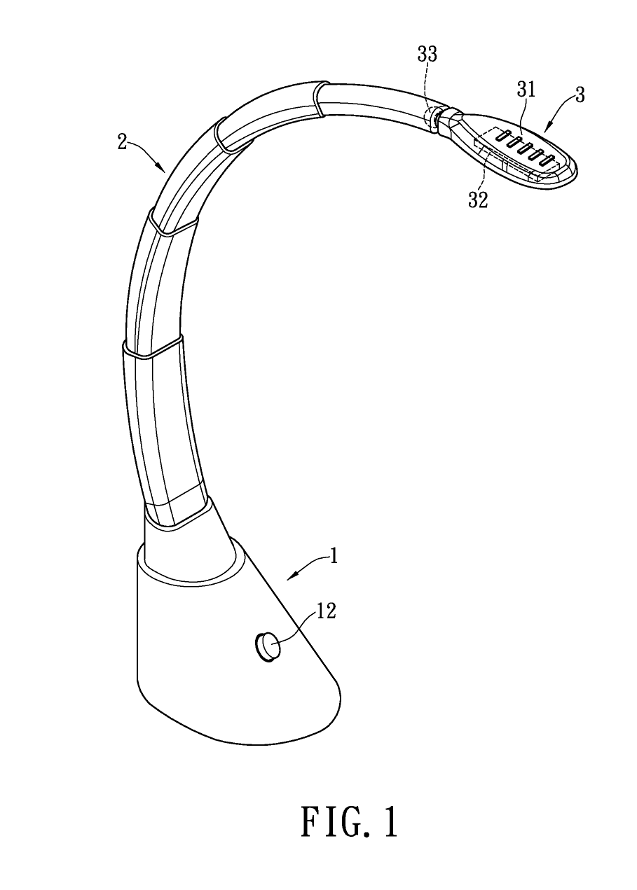

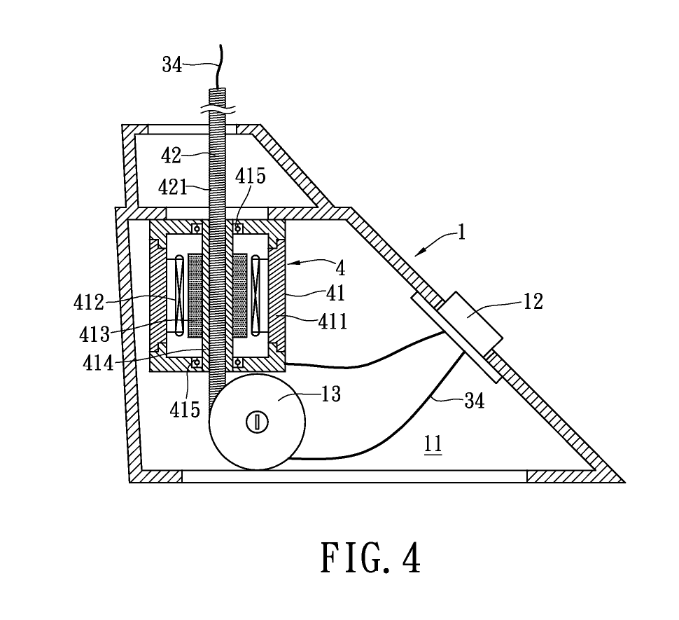

With reference to FIGS. 1-3, the instant disclosure provides a telescopic illuminating device applicable on, but not limited to, floor lamps, table lamps and so on. The telescopic illuminating device includes a base support 1, a telescopic shaft 2, a light source (lamp head) 3, and a driving mechanism 4. The base support 1 is a rigid base body disposable on floor or on tables and etc. A receiving space 11 (shown in FIG. 4) is formed internally of the base support 1 to accommodate the driving mechanism 4. A switch member 12 is arranged on the base support 1 or other appropriate locations, where the switch member 12 is electrically connected to the light source 3 and the driving mechanism 4. More specifically, the switch member 12, other than the switch function and the ability to control the luminous intensity of the light source 3, can also control the driving mechanism 4. As for the telescopic shaft 2, the lower end thereof (the end proximate to the base support 1) is connected to the base support 1, while the upper end thereof (the end proximate to the light source 3) is connected to the light source 3. The driving mechanism 4 can be arranged within the receiving space 11 or any other appropriate locations on the base support 1. Furthermore, the driving mechanism 4 is attached to the telescopic shaft 2, in other words, the driving mechanism 4 can be connected to the one end, namely the lower end, of the telescopic shaft 2 to drive the extension or retraction motion of the telescopic shaft 2.

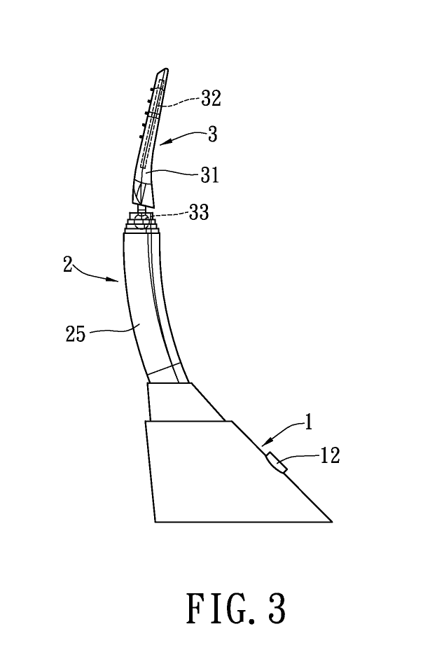

The telescopic shaft 2 is a multi-sectional structure formed of an assembly of telescoped subshafts, where the amount of subshafts is not limited, and can be increased or reduced according to the requirements. For the instant embodiment, the telescopic shaft 2 includes a first subshaft 21, a second subshaft 22, a third subshaft 23, a fourth subshaft 24, and a fifth subshaft 25 in a telescopic arrangement. Each of these sub-shafts has different caliber which gradually increases in a direction toward the base support 1. In other words, the caliber of the first subshaft 21 is the smallest while the caliber of the fifth shaft 25 being the largest. For the instant embodiment, the fifth subshaft 25 of the telescopic shaft 2, having the largest caliber, is connected to the base support 1, while the first subshaft 21 having the smallest caliber is connected to the light source 3. Thereby, the light source 3 is connected to the base support 1 through the telescopic shaft 2. When the subshafts are arranged in extended condition, the telescopic shaft 2 can utilize means such as snap-in means, gradient, or other engaging structures to prevent detachment. Due to the fact that the engaging structure is already a well known technique and is not claimed by the instant disclosure, no further related descriptions are provided herein. Whereas in the retracted condition, the first through fourth subshafts 21˜24 are telescoped within the fifth subshaft 25 which has the largest caliber for space saving (shown in FIG. 3).

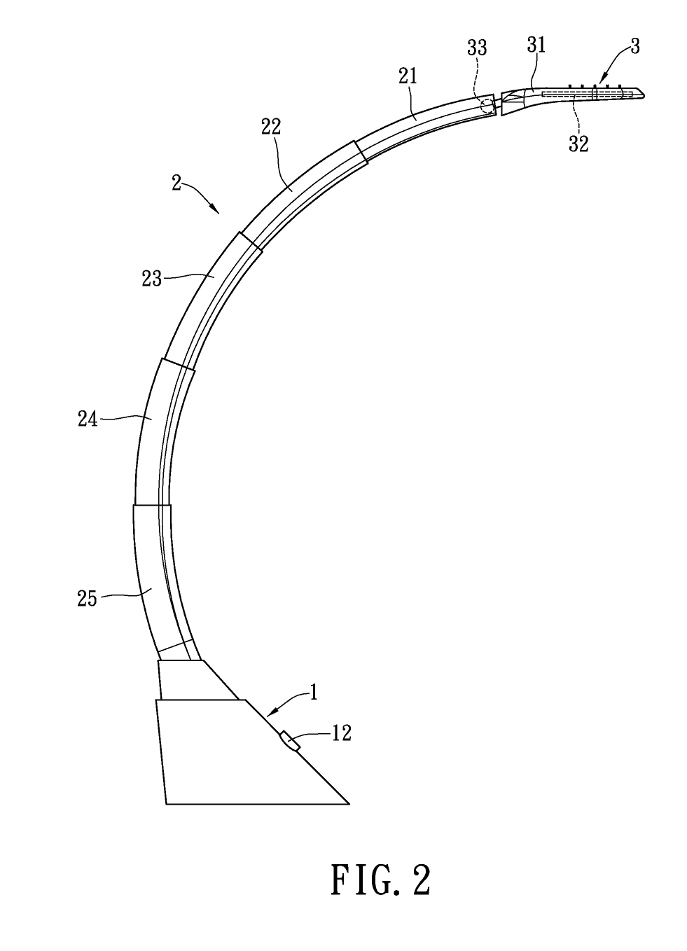

The telescopic shaft 2 of the instant disclosure has a curvature, in other words, the telescopic shaft 2 is substantially an arched structure. For another embodiment, the telescopic shaft 2 does not have a curvature, in other words, the telescopic shaft 2 is substantially a straight erecting structure. Furthermore, each of the subshafts 21-25 of the arched telescopic shaft 2 is also an arched structure. Thereby, the telescopic shaft 2 will form a curved structure when extended (shown in FIG. 2). Therefore, the light source 3 is adjustable not only in the vertical direction, but also in the horizontal direction as well. As shown by the orientation in FIG. 2, the light source 3 is adjustable to the right (forward) or to the left (backward). Contrarily, the straight erecting telescopic shaft 2 can only adjust the light source 3 in the vertical direction to reach different height levels.

The form of the light source 3 is not restrict thereto and can be changed accordingly to the requirements. The light source 3 includes a holder 31 and a lighting element 32 arranged therein. For the instant embodiment, the lighting element 32 is, but not limited to, a light emitting diode (LED), for the lighting element 32 can also be a light bulb or any other type of lighting element. The light source 3 is connected to one end of the telescopic shaft 2, in other words, the light source 3 is connected to the first subshaft 21 of the telescopic shaft 2. More specifically, the light source 3 can be connected to the telescopic shaft 2 through a universal joint 33 to enable vertical and horizontal adjustments of the light source 3. Thereby, enabling the light source 3 to be adjustable in different directions and positions. The light source 3 can also be connected to a wire 34, which is connected electrically to an appropriate power source. Moreover, the wire 34 can be connected electrically to the switch member 12.

Please refer to FIG. 4. For the instant embodiment, the driving mechanism 4 includes a motor 41 and a flexible member 42 connected thereto. The motor 41 includes a housing 411, and a stator 412 together with a rotor 413 arranged within the housing 411. The stator 412 can be a coil while the rotor 413 can be a permanent magnet. A threaded bushing 414 is projected centrally through the rotor 413. The threaded bushing 414 and the rotor 413 are supported within the housing 411 through a bearing 415. Thereby, the threaded bushing 414 and the rotor 413 can rotate freely therein. The motor 41 is connected electrically to an appropriate power source. However, the motor 41 can be also connected electrically to the switch member 12. When electrical power is transmitted to the motor 41, the rotor 413 will be driven to rotate the threaded bushing 414. The flexible member 42 is a hollow structure capable of accommodating the wire 34 of the light source 3. Thus, the wire 34 can be protected within the flexible member 42 to avoid short-circuit or damages due to wire entanglement.

The coilable member 42 is an elongated component with sufficient length having a threaded outer surface 421. For the instant embodiment, the flexible member 42 is a screw-like spring, where the threaded outer surface 421 is defined by the external surface of the screw-like spring. The flexible member 42 is projected through the threaded bushing 414 of the motor 41, where the threaded outer surface 421 of the flexible member 42 is meshed to the threaded bushing 414. One end of the flexible member 42 is connected to one end (upper end) of the telescopic shaft 2. In other words, one end of the flexible member 42 is connected to the first subshaft 21 of the telescopic shaft 2. Whereas the other end of the flexible member 42 is affixed to the base support 1. When the threaded bushing 414 of the motor 41 rotates, the flexible member 42 is rotatably driven away or toward the base support 1 through the mating threads. Thereby, the telescopic shaft 2 can be extended or retracted in an automated manner to change the position of the light source 3.

Additionally, the instant disclosure can further arrange a roll-in mechanism 13 in the receiving space 11 of the base support 1, where the roll-in mechanism 13 may be a disc- or rail-shaped structure. The flexible member 42 can be selectively retrieved by the roll-in mechanism 13. In other words, the flexible member 42 can retract smoothly into the base support 1 through the guidance of the roll-in mechanism 13 to store orderly therein. However, the flexible member 42 can also be coiled and stored within the receiving space 11 even if the roll-in mechanism 13 is not provided.

### The Second Embodiment

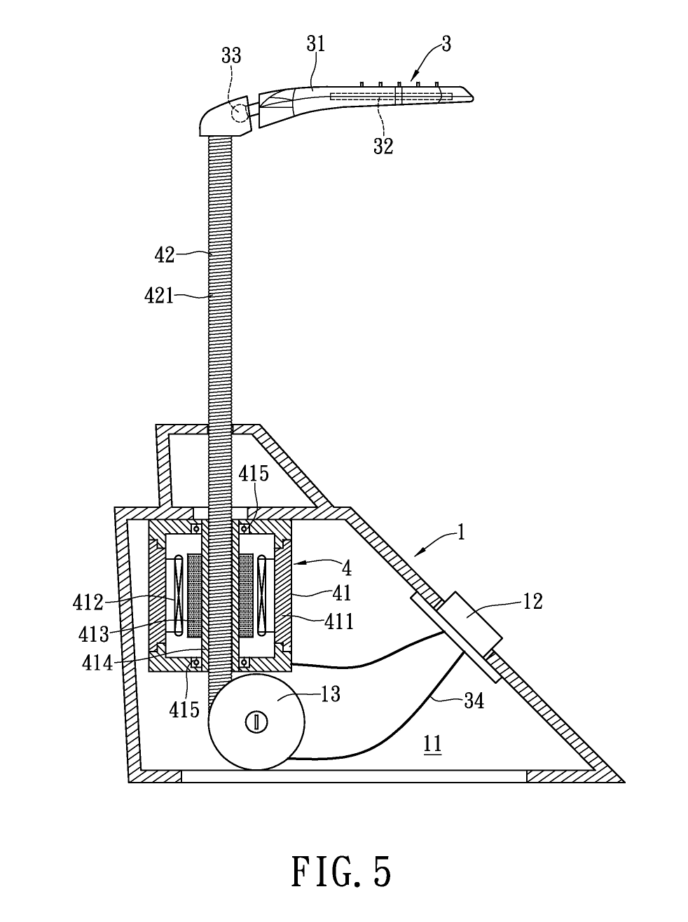

Please refer to FIG. 5. For the second embodiment of the instant disclosure, the telescopic shaft 2 of the preceding embodiment is being omitted. The illuminating device of the instant embodiment includes the base support 1, the light source 3, and the driving mechansim 4. The driving mechanism 4 is arranged within the receiving space 11 of the base support 1, where one end of the flexible member 42 is connected to the light source 3. Due to the fact that the other features of the instant embodiment are substantially the same as the preceding embodiment, no further descriptions shall be provided herein. When the threaded bushing 414 of the motor 41 rotates, the flexible member 42 will be driven away or toward the base support 1 through the mating threads. Thereby, the light source 3 can be driven by the driving mechanism 4 to be vertically adjustable to reach different height levels. As the telescopic shaft 2 is excluded in the instant embodiment, the light source 3 herein is supported solely by the flexible member 42 of the driving mechanism 4. Therefore, in comparison to the preceding embodiment, a stronger flexible member 42 is required to support the light source 3 stably when the flexible member 42 extends out of the base support 1. Meanwhile, the flexible member 42 requires sufficient flexibility to be accommodated within the receiving space 11 of the base support 1.

### The Third Embodiment

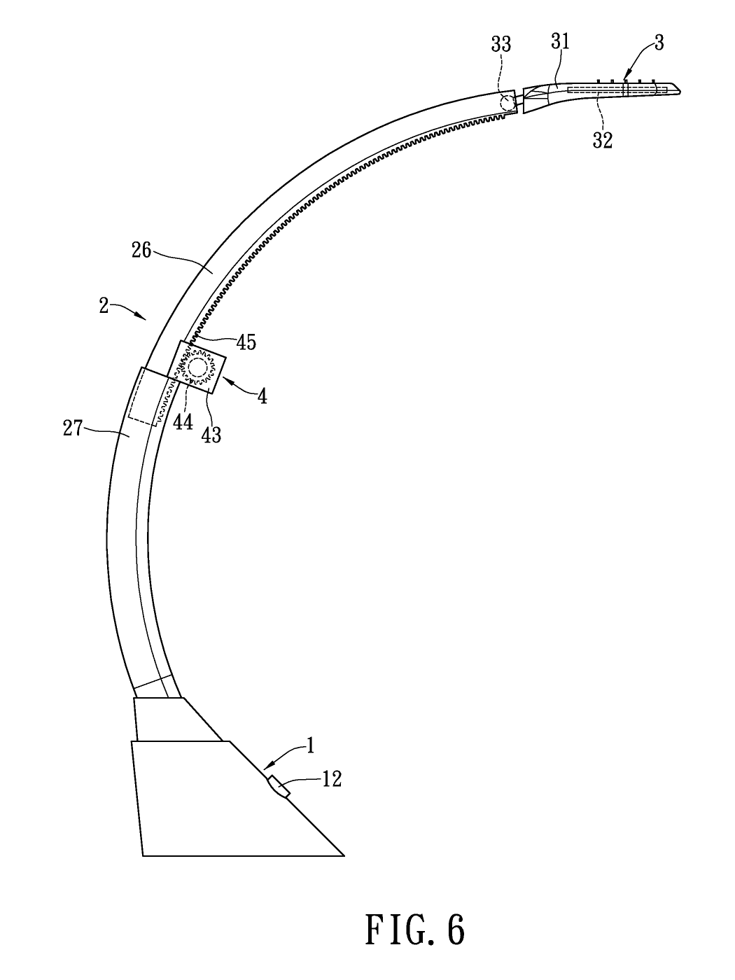

Referring now to FIG. 6. For the third embodiment of the instant disclosure, the telescopic shaft 2 is formed by a first subshaft 26 which is telescoped to a second subshaft 27. Furthermore, the second subshaft 27 of the telescopic shaft 2, having a larger caliber is connected to the base support 1 while the first subshaft 26, having a smaller caliber is connected to the light source 3. Thereby, the light source 3 is connected to the base support 1 through the telescopic shaft 2. The driving mechanism 4 is attached to the telescopic shaft 2 for enabling the telescopic shaft 2 to perform extension or retraction motions. The driving mechanism 4 of the instant embodiment includes a motor 43, a gear 44, and a rack 45. The motor 43 is affixed to the distal end of the second subshaft 27, proximate to the first shaft 26, while the gear 44 is connected to the output shaft of the motor 43; and the rack 45 is arranged on one side of the first subshaft 26 in an elongated manner. The gear 44 and the rack 45 are mutually engaged to form a gear assembly on the telescopic shaft 2. When the motor 43 is turned on, the gear 44 rotates, where the rotational motion applied to the gear 44 causes the rack 45 to move, thereby translating the rotational motion of the gear 44 into the linear motion of the rack 45. In other words, the first subshaft 26 is enabled to move extendably or retractably for adjusting the position of the light source 3.

The light source 3 of the instant disclosure is adjustable by the driving mechanism 4 to be vertically adjustable to reach different height levels. Thereby, facilitating the users of adjusting the light source 3 to their desire height levels to provide a better illumination, so as to achieve the effect of, “bringing the light to the users”. Additionally, the light source 3 of the instant disclosure can be adjusted vertically through automated manner to provide easy operation.

Furthermore, the telescopic shaft 2 of the instant disclosure can be designed as an arched structure such that the telescopic shaft 2 will arch when extends. Therefore, the light source 3 is not only adjustable in the vertical direction, but also in the horizontal direction to provide a more complete adjustment of the light source 3.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims

What is claimed is:

1. A telescopic illuminating device, comprising:
a base support;
a telescopic shaft having one end connected to the base support;
a light source connected to an opposite end of the telescopic shaft; and
a driving mechanism connected to the telescopic shaft.

2. The telescopic illuminating device according to claim 1, wherein the telescopic shaft has a curvature.

3. The telescopic illuminating device according to claim 1, wherein the telescopic shaft is constructed by an assembly of telescoped subshafts, wherein each subshaft has a different caliber, and wherein the subshaft having the largest caliber is connected to the base support, while the subshaft having the smallest caliber is connected to the light source.

4. The telescopic illuminating device according to claim 1, wherein the light source is connected to the telescopic shaft through a universal joint.

5. The telescopic illuminating device according to claim 1, wherein the driving mechanism includes a motor and a flexible member connected therewith, wherein the flexible member is a hollow structure, and wherein a wire is connected to the light source and accommodated within the flexible member.

6. The telescopic illuminating device according to claim 5, wherein the motor has a housing and a stator together with a rotor arranged therein, wherein a threaded bushing is projected centrally through the rotor, wherein the flexible member is an elongated structure having a threaded outer surface, wherein the threaded outer surface of the flexible member is in mesh with the inner threads of the threaded bushing, while one end of the flexible member is connected to the telescopic shaft.

7. The telescopic illuminating device according to claim 6, wherein the flexible member is a screw-like spring.

8. The telescopic illuminating device according to claim 5, wherein a receiving space is formed internally of the base support to accommodate the driving mechanism, and wherein a roll-in mechanism is arranged within the receiving space of the base support for selectively storing the flexible member.

9. The telescopic illuminating device according to claim 1, further comprising a switch member electrically connected to the light source and the driving mechanism.

10. The telescopic illuminating device according to claim 1, wherein the driving mechanism is attached to the telescopic shaft.

11. An telescopic illuminating device, comprising:
a base support;
a driving mechanism arranged within the base support; and
a light source connected to the driving mechanism.

12. The telescopic illuminating device according to claim 11, wherein the driving mechanism includes a motor and a flexible member connected therewith, wherein the flexible member is a hollow structure, and wherein a wire is connected electrically to the light source and accommodated within the flexible member.

13. The telescopic illuminating device according to claim 12, wherein the motor includes a housing and a stator together with a rotor arranged within the housing, wherein a threaded bushing is projected centrally through the rotor, wherein the flexible member is an elongated structure having a threaded outer surface in mesh with the internal threads of the threaded bushing, while one end of the flexible member is connected to the light source.

14. The telescopic illuminating device according to claim 13, wherein the flexible member is a screw-like spring.

15. The telescopic illuminating device according to claim 12, wherein a receiving space is formed internally of the base support to accommodate the driving mechanism, and wherein a roll-in mechanism is arranged within the receiving space of the base support, to selectively store the flexible member.

16. The telescopic illuminating device according to claim 11, further comprising a switch member electrically connected to the light source and the driving mechanism.
